(19) United States
(12) Patent Application Publication
(10) Pub. No.: US 2008/0202657 A1
(43) Pub. Date: Aug. 28, 2008

(54) Arrangement for Pressure Measurement

(75) Inventor: Ernst Hammel, Vienna (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: ELECTROVAC AG, Klostemeuburg (AT)

(21) Appl. No.: 11/917,282

(22) PCT Filed: May 29, 2006
(86) PCT No.: PCT/AT2006/000219

§ 371 Date: Dec. 12, 2007

(30) Foreign Application Priority Data
Jun. 14, 2005 (AT) A 1003/2005

(51) Int. Cl. B60C 19/00; B60C 23/02

(52) U.S. Cl. 152/152.1; 73/146.5

(57) ABSTRACT

In an arrangement for measuring pressure, in particular in gas-filled tyres (1), comprising at least one surface wave sensor (2) with a piezoelectric carrier substrate (3), with at least one exciter electrode (4) and at least one receiver electrode (5) being arranged on at least one surface of the carrier substrate (3) and the surface wave sensor (2) being connected at least in certain areas to a surface (6) which deforms under the influence of the pressure to be measured, in particular stretches and/or curves, it is proposed, in order to form a simple, cost-effective, robust and lightweight tyre pressure measuring device, that the carrier substrate (3) comprises at least one nanoscale carbon, preferably carbon fullerene, carbon nanofibres or carbon nanotubes.

The invention relates to an arrangement for measuring pressure, especially for gas-filled tires, comprising at least one surface-wave sensor with a piezoelectric carrier substrate, with at least one exciter electrode and at least one receiver electrode being arranged on at least one surface of the carrier substrate, with the surface-wave sensor being connected at least in certain areas to a surface which deforms under the influence of the pressure to be measured, especially stretches and/or curves.

Surface-wave components are piezoelectric components which are used for a large variety of applications (frequency filters, reference oscillators) in high-frequency technology. Waves are generated on the surface of piezoelectric bodies (e.g. quartz, ZnO) whose longitudinal component expands with slight damping parallel to the surface, whereas the transversal component is strongly dampened perpendicular to the surface and penetrates the substrate only approximately one wavelength deep. Such waves can be excited in an electrostrictive manner with the help of vapor-deposited interdigital electrodes which consist of equidistant metal webs which engage into each other in a comb-like manner.

The wavelength of the surface wave is determined by the distance of two adjacent webs of the comb electrode. Said surface wave can be received by a second pair of interdigital electrodes as an electric signal, with typical wavelengths lying in the range of 10 μm. As a result of the speed of sound of the electric body, the frequency is obtained which typically lies at approximately 300 MHz when using quartz for example with a speed of sound of approximately 3100 m/sec.

Since the wavelength is predetermined by the structure of the exciter electrodes, any changes in the velocity of propagation by expansion or change of temperature in the surface lead to a change in the frequency. Expansion can also lead to a change in the distance between the webs, thus having a direct influence on the wavelength, which also has an effect on the frequency.

Monitoring tire pressure can be important for driving safety. As a result of insufficient inflation, the service life of the tires will decrease, and fuel consumption and likelihood of turning over will increase. Three-quarters of all flat tires are caused by insufficient inflation or creeping loss of pressure, with flat tires being the third most frequency cause of breakdowns for motor vehicles. Monitoring the tire pressure will therefore increase the service life of the tires, reduce fuel consumption and reduce the frequency of breakdowns or likelihood of turning over.

A system for monitoring the tire pressure by means of a piezoelectric sensor is known, with the sensor being expanded under the influence of tire pressure and the capacitance of the sensor changing. The sensor is the effective capacitance in an oscillating circuit which is inductively coupled to a further oscillating circuit which is arranged in the vehicle close to the tire. The resonance frequency of the oscillating circuit changes by changing the capacitance of the sensor. It is possible to conclude the prevailing pressure by evaluating said frequency shift. The disadvantageous aspect in such an arrangement is the high complexity and the high moved masses which lead to a serious unbalance of the tire.

An additional factor is the lack of mechanical stability of conventional piezoelectric components and their short life, especially when used in environments that are subjected to high thermal and mechanical stresses. The low thermal conductivity of conventional piezoelectric components easily leads to wrong measurements in environments subject to high alternating thermal stresses as a result of wrong or lack of temperature compensation.

Pressure sensors are further known which comprise piezoelectric sensors which are arranged on a membrane which changes or deforms under the influence of pressure, with said piezoelectric sensors being operated in the manner of resistance strain gauges in an active resistance bridge. In addition to the disadvantages already mentioned, there is another factor in that active power supply is necessary for its operation.

It is therefore the object of the invention to provide an arrangement for measuring pressure of the kind mentioned above, with which the mentioned disadvantages can be avoided, which has compact dimensions, has a simple structure, is easy and cheap to produce, has a low mass, heats up evenly and adjusts rapidly to changed thermal ambient conditions, is not susceptible to static charging, sturdy against mechanical and chemical stresses, and can be applied flexibly in different applications and is environmentally friendly.

This is achieved in such a way that the carrier substrate comprises at least one nanoscale carbon, preferably carbon fullerene, carbon nanofibers or carbon nanotubes.

An arrangement for pressure measurement can thus be created which is thermally and chemically stable in a wide range, which is insensitive to mechanical stress such as jolting or bending, which can be produced easily and flexibly, which offers favorable thermal conductivity and thus can adjust rapidly to changing thermal environments, which has favorable electric conductivity and is insensitive to static charging, and which can be recycled completely and be burned without any residue.

It can be provided in a further development of the invention that the carrier substrate comprises a polymer, especially polyamide, polyurethane, epoxide, synthetic rubber, PEEK and/or LCP which contain nanoscale carbons. A carrier substrate can thus be produced easily and in many areas has the positive properties of the respective materials. As compared with conventional piezoelectric carrier substrates, such a carrier substrate is flexible, extensible and bendable within wide margins. It is further impact-resistant and shows little brittleness.

In this connection it can be provided in a further development of the invention that the at least one exciter electrode is connected with at least one receiver antenna and/or that the at least one receiver electrode is connected with at least one transmitting antenna. It is thus possible to inject by radiation the excitation energy via an electromagnetic field or to transmit the high-frequency electric energy transmitted by the receiver electrode. This allows creating an arrangement for measuring pressure which is passive and is supplied with energy merely from the outside. As a result of the lack of power supply, it is even more compact, lighter, cheaper in production and can be stored virtually limitless, but at least longer than the life of the tire.

According to a further embodiment of the invention it can be provided that a voltage source, especially a battery and/or a storage battery, is provided. Higher transmitting powers can thus be realized. It is thus possible to send the data to a receiver which is not arranged directly in the vicinity close to the tire. The data of all tires of a vehicle can thus be sent directly to a centrally arranged receiver.

According to another embodiment of the invention it can be provided that the surface-wave sensor is connected with a membrane of an evacuated pressure capsule and/or it is arranged in an integral manner with the membrane. The defined bending of a membrane against a known gas pressure can thus be determined, which thus allows drawing very precise conclusions on the prevailing pressure. The integral arrangement allows omitting a separate carrier, thus saving an additional component and reducing both the costs, the production work and the mass.

A variant of the invention can be that the surface-wave sensor is arranged integrally with a tire, with the tire forming the carrier substrate and containing nanoscale carbon at least in the area of the surface-wave sensor. The bending of a flexible surface, which is the tire surface, can be measured under the influence of tire pressure and thus the tire pressure can be determined by avoiding a separate evacuated pressure capsule.

In a further arrangement of the invention it can be provided that at least the exciter electrode and/or at least the receiver electrode is encompassed or covered by a flexible protective jacket. Damage to the same can thus be prevented.

It can be provided in a further development of the invention that means for temperature measurement are provided. Temperature influences can thus be compensated or taken into account effectively.

Another possible embodiment can be that the means for temperature measurement comprise at least one temperature-sensitive resistor, with preferably the temperature-sensitive resistor being arranged integrally in certain areas with the at least one exciter electrode and/or the at least one receiver electrode. This allows simple measurement of the temperature.

The invention further relates to a tire, provided for filling with a gas, with it being provided for measuring the tire pressure and the pressure of the gas in the gas-filled tire that at least one arrangement for measuring pressure is provided, preferably at a location which is subjected to little thermal stress.

The tire pressure can thus be checked and verified in a tire during operation. Underinflation/overinflation and changing tire pressure, especially a falling one, can be detected in time, thus preventing accidents and flat tires and making life more secure for other drivers. A tire can be created by using an arrangement in accordance with the invention for measuring the pressure in a tire which can be operated and/or stored over a prolonged period of time with unimpaired operational readiness of the arrangement for pressure measurement, which does not have any noteworthy unbalances and can be produces in a cost-effective way.

In a further development of the invention it can be provided that the at least one arrangement for measuring pressure is arranged on the inside surface or inside layer of the tire. The arrangement for measuring pressure in accordance with the invention is thus permanently protected from damage by outside foreign bodies.

In this connection it can be provided for in a further development of the invention that the at least one arrangement for measuring pressure is integrated in the inner arrangement of the tire, especially in the area of a layer of fabric, a belt, the inner structure or the carcass. An especially effective protection of the arrangement for measuring pressure in accordance with the invention can thus be achieved. Damage while handling the tires in a repair shop or during storage can thus be effectively prevented.

The invention is now explained in closer detail by reference to the enclosed drawings which merely show preferred embodiments, wherein:

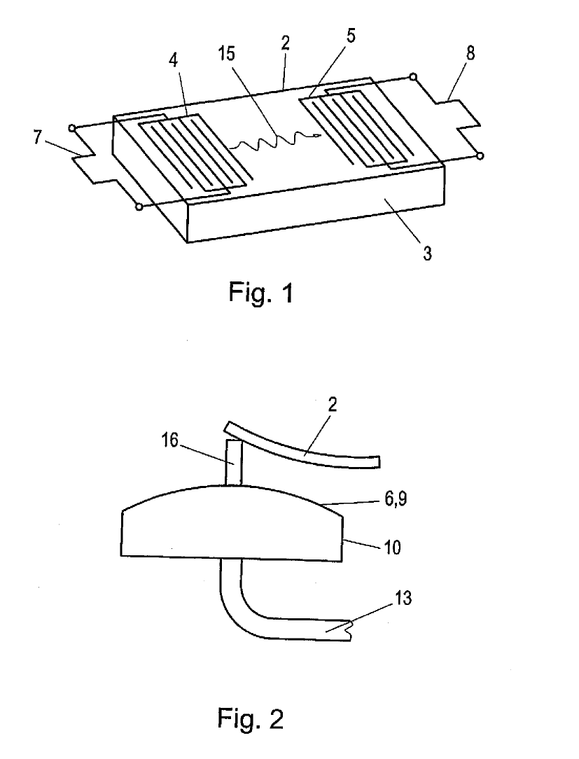

FIG. 1 shows a first preferred embodiment of an arrangement for measuring pressure;

FIG. 2 shows a second preferred embodiment of an arrangement for measuring pressure;

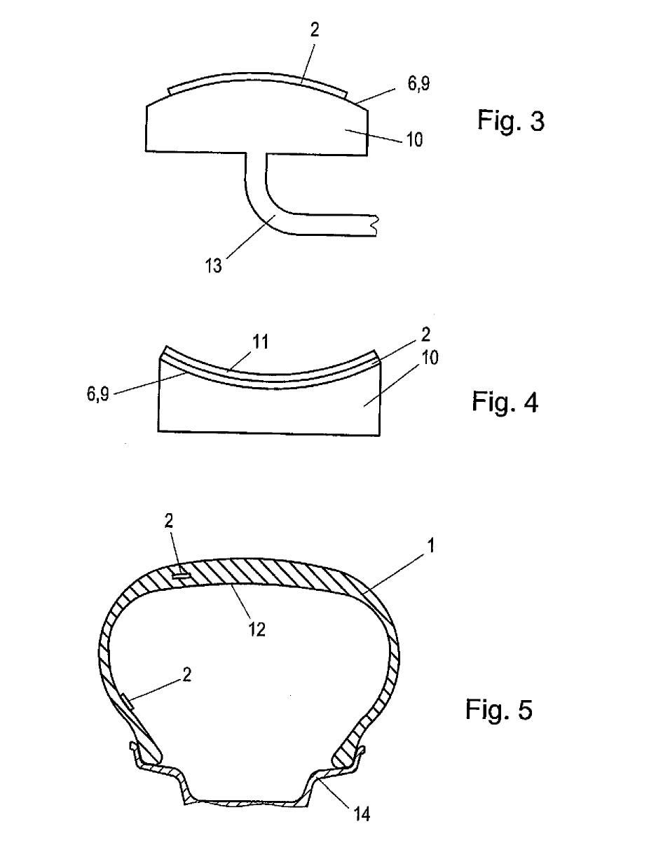

FIG. 3 shows a third preferred embodiment of an arrangement for measuring pressure;

FIG. 4 shows a fourth preferred embodiment of an arrangement for measuring pressure;

FIG. 5 shows a tire in a sectional view with two arrangements for measuring pressure in accordance with the invention, and

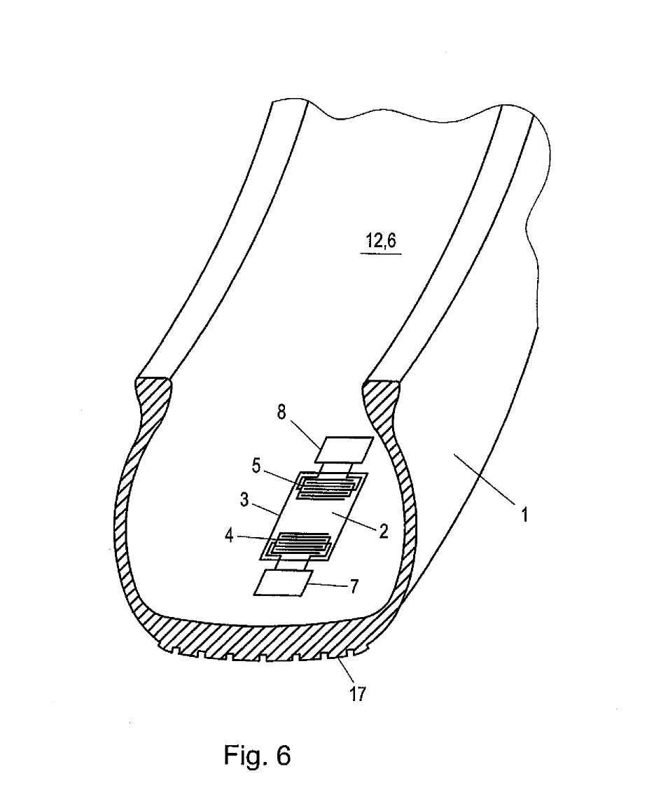

FIG. 6 shows a tire in a sectional view with a first arrangement for measuring pressure in accordance with the invention;

FIGS. 1 to 6 show embodiments and individual parts of an arrangement for measuring pressure, especially in the case of gas-filled tires 1, comprising at least one surface-wave sensor 2 with a piezoelectric carrier substrate 3, with at least one exciter electrode 4 and at least one receiver electrode 4 being arranged on at least one surface of the carrier substrate 3, with the surface-wave sensor 2 being connected at least in certain areas with a surface 6 which deforms under the influence of the pressure to be measured, especially stretches and/or curves, with the carrier substrate comprising at least one nanoscale carbon, preferably carbon fullerene, carbon nanofibers or carbon nanotubes.

Arrangements for measuring pressure in accordance with the invention are characterized in that they are thermally and chemically stable in a wide range, insensitive to mechanical stresses such as impacts or bending, can be produced in a simple and flexible way, have a favorable thermal conductivity and can thus adjust rapidly to changing thermal environments, they have a favorable electric conductivity and are insensitive to static charging, and can be recycled completely and burned without any residue.

It is preferably provided that the arrangements for measuring pressure in accordance with the invention are used in tires 1 or installed in such which are provided for filling with a gas, preferably air and/or nitrogen. It can further be provided that contact points are provided, especially receivers and/or evaluation units, for making especially wireless contact or connection with the at least one arrangement for measuring pressure in machines which are provided directly and/or indirectly for continual and/or temporary operation with such tires 1. Such machines can concern motor vehicles such as cars, motorcycles, underground vehicles, or aircraft. It is preferably also provided to equip maintenance machines such as tire filling apparatuses and/or tire pressure checking apparatuses or places such as garages, gas stations and/or toll booths with such contact points. It is further possible to provide portable devices for reading out the pressure information for maintenance crews and the police for example.

FIG. 1 shows a simple embodiment of an arrangement for measuring pressure in accordance with the invention. It is formed by a surface-wave sensor 2 (also known as surface acoustic wave device, i.e. SAW device). At least one exciter electrode 4 and at least one receiver electrode 5 are arranged on a carrier substrate 3.

In the invention, the carrier substrate 3 comprises at least one nanoscale carbon, preferably carbon fullerene, carbon nanofibers or carbon nanotubes. Nanoscale carbon concerns large accumulations of carbon atoms. They are preferably arranged in regular structures and form an intermediate stage between molecules and solid bodies. A frequent form of nanoscale carbon is the C₆₀ molecule which is also detectable in nature as a residue of interstellar processes and has a symmetric ball structure.

As a result of the similarity of the regular arrangements of atoms with geodetic domed buildings by the US architect Richard Buckminster Fuller, such nanoscale carbons are also known as carbon fullerenes. The oblong nanoscale carbon molecules are known as carbon nanofibers, carbon nanotubes, nanotubes or buckytubes. Nanoscale carbons have piezoelectric properties.

It is preferably provided that the carrier substrate 3 comprises a polymer, especially polyamide, polyurethane, epoxide, synthetic rubber, PEEK and/or LCP which contain nanoscale carbons. A carrier substrate 3 can thus be formed which can be produced at low cost in different shapes and which is flexible and extensible. As a result, such a preferred carrier substrate 3 can also be used for applications for which conventional brittle carrier substrates such as quartz cannot be used.

In the first preferred embodiment according to FIG. 1, a pair each of exciter electrodes 4 and a pair of receiver electrodes 5 are provided, arranged on the surface of carrier substrate 3. It can be provided to embed the exciter electrodes 4 and/or the receiver electrodes 5 in the preferably polymer carrier substrate 3. It can also be provided to arrange the exciter electrodes 4 and/or the receiver electrodes 5 on the surface of carrier substrate 3 by means of photolithographic processes, vapor deposition of a conductive layer and/or etching processes. The exciter electrodes 4 and/or the receiver electrodes 5 can comprise any conductive element. It is preferably provided that the exciter electrodes 4 and/or the receiver electrodes 5 contain the metals of copper, silver, gold and/or aluminum. For protecting the exciter electrodes 4 and/or the receiver electrodes 5 it can be provided that at least the exciter electrode 4 and/or at least the receiver electrode 5 are encompassed or covered by a flexible protective jacket 11. Such a protective jacket 11 can be formed by a polymer for example, and it may be provided that it may concern the polymer of the same kind that is preferably used as a carrier or filling material for the nanoscale carbon.

The exciter electrodes 4 and/or the receiver electrodes 5 are formed in the preferred embodiments by two electrodes each which engage into each other in a comb-like fashion, with a change in the wavelength of the surface wave 15 occurring by deformation of the surface-wave sensor 2.

It can be provided that the exciter electrode 4 is connected with an electronic circuit which generates a high-frequency alternating voltage and which can be connected with a battery and/or storage battery for power supply. It is preferably provided that the at least one exciter electrode 4 is connected with at least one receiver antenna 7. This ensures that the power required for operation can be drawn from an electromagnetic field. Irrespective of the kind of power supply it is preferably provided that the at least one exciter electrode 5 is connected with at least one transmitting antenna 8. The frequency of the emitted electromagnetic radiation supplies information on the degree of deformation or deflection of the surface sensor 2. Since transmitter and receiver use the same frequency reference, coherent detection and thus measurement of differential phases for increasing resolution are possible. Since the exciting alternating voltage is transmitted by radio, the surface-wave sensors 2 are passive maintenance-free components which do not need any additional supply voltage.

It can also be provided to use active and/or passive RFID transponders for receiving and/or transmitting the data.

A signal processing unit can be provided for evaluating the frequency information. It can be provided both in the direct vicinity of the surface-wave sensor 2 as well as in the area of a contact point, especially a receiver, which receives the electromagnetic radiation emitted by means of the antenna from the surface-wave sensor 2.

It can be provided to provide a central contact point for the simultaneous operation of several arrangements for pressure measurement. It can also be provided to provide a contact point adjacent to each arrangement for measuring the pressure.

FIG. 2 shows a second preferred embodiment of an arrangement for measuring pressure in accordance with the invention. The gas to be measured under pressure is guided via a feed line 13 to a pressure capsule 10 which is evacuated with calibrated or known pressure relative to an atmosphere. The expansion or deformation of a membrane 9 of the pressure capsule 10 is transmitted to a tappet 16. Said tappet 16 bends or deforms the surface-wave sensor 2 which detects and transmits the deformation and deflection in the manner already explained above.

As a result of the deformation and deflection capability of an arrangement for measuring pressure in accordance with the invention, it can be provided, as shown in FIGS. 3 and 4, to arrange the at least one surface-wave sensor 2 in a preferably direct manner on a membrane 9 of a pressure capsule 10. It can preferably be provided that the membrane 9 of the pressure capsule 10 is itself formed by the surface-wave sensor 2 or the carrier substrate 3 of the surface-wave sensor 2. This ensures a direct transmission without any time lag of the pressure from the pressure capsule 10 to the surface-wave sensor 2.

FIG. 3 shows an arrangement which is analogous to FIG. 2, comprising a feed line 13 for the gas under pressure.

FIG. 4 shows an evacuated pressure capsule 10 which is filled with a gas under known pressure and is arranged in an environment with the pressure to be measured. The ambient pressure deforms the membrane 9 and thus also the surface-wave sensor 2. In this embodiment, the surface-wave sensor 2 is covered with a flexible protective jacket 11.

Since a drifting of the measurement results may occur as a result of changes in temperature, it can be provided to provide means for temperature measurement and to have the results of the measurement of the data sent by the at least one surface-wave sensor included in an evaluation of the measurement data. Such means for temperature measurement can comprise at least a temperature-sensitive resistor such as an NTC or PTC resistor and/or a thermocouple. In a preferred embodiment it can be provided that the temperature-sensitive resistor is arranged at least in certain areas in an integral manner with the at least one exciter electrode 4 and/or the at least one receiver electrode 5.

It can be provided to provide an arrangement for pressure measurement in accordance with the invention at each point of a tire 1 which is provided for filling with gas or which is filled with gas. It can also be provided to arrange an arrangement for measuring pressure in accordance with the invention on a rim 14 or a part associated with the rim 14. It can also be provided to arrange an arrangement for measuring pressure in accordance with the invention on a valve. Moreover, it can be provided, especially for reasons of redundancy, higher precision of the measurement data and reduction of unbalance, to provide more than one arrangement for pressure measurement at one of the mentioned points or at different points of a tire.

When arranged on a tire 1, it is preferably provided to arrange the arrangement for measuring pressure at a position that is subject to little thermal stress. It can be provided to arrange the arrangements of measuring pressure in accordance with the invention both on the inner surface 12 of a tire 1 as well as in the interior of tire 1, especially in the region of fabric layer, a belt, the inner structure or the carcass. It can especially be provided that the surface-wave sensor 2 is arranged integrally with the tire 1, with the tire 1 forming the carrier substrate 3 and containing nanoscale carbon at least in the area of the surface-wave sensor 2. It can be provided in this respect to fill parts of the tire 1 at least in certain areas with nanoscale carbon instead of the technical carbon black.

FIG. 6 shows an especially preferred embodiment of an arrangement for measuring pressure in accordance with the invention. A surface-wave sensor 2 is arranged on the inside 12 opposite of the tread 17 of tire 1. Since the tread 17 is flexed less than the side walls 18 of tire 1, it has a lower amount of heating than the side walls 18. In the especially preferred embodiment, the exciter electrodes 4 are connected with at least one receiver antenna 7 and the at least one receiver electrode 5 with at least one transmitter antenna 8. The power required for operation is injected by radiation from the outside and further processing and analysis of the emitted signals is also made elsewhere.

Such an arrangement for pressure measurement has an exceptionally low mass and thus leads to low unbalance. An additional factor is that such an arrangement for measuring pressure works in a purely passive manner and therefore can be operated and stored in a wear-free manner over a prolonged period of time.

Further embodiments in accordance with the invention merely have a part of the described features, with any combination of features, which especially also include those of different described embodiments, being provided.

1.-12. (canceled)

13. An arrangement for measuring pressure, especially for gas-filled tires, comprising:
at least one surface-wave sensor with a piezoelectric carrier substrate; and
at least one exciter electrode and at least one receiver electrode being arranged on at least one surface of the carrier substrate,
wherein the surface-wave sensor is connected at least in certain areas to a surface which deforms under the influence of pressure to be measured,
wherein the carrier substrate comprises at least one nanoscale carbon for realizing piezoelectric properties.

14. The arrangement of claim 13, wherein the surface stretches and/or curves under the influence of the pressure to be measured.

15. The arrangement of claim 13, wherein the nanoscale carbon is a member selected from the group consisting of carbon fullerene, carbon nanofibers, and carbon nanotubes.

16. The arrangement of claim 13, wherein the carrier substrate comprises a polymer which contains nanoscale carbons.

17. The arrangement of claim 16, wherein the polymer is at least one member selected from the group consisting of polyamide, polyurethane, epoxide, synthetic rubber, PEEK, and LCP.

18. The arrangement of claim 13, wherein the at least one exciter electrode is connected with at least one receiver antenna, and/or the at least one receiver electrode is connected with at least one transmitting antenna.

19. The arrangement of claim 13, further comprising a voltage source for power supply.

20. The arrangement of claim 19, wherein the voltage source is a battery and/or a storage battery.

21. The arrangement of claim 13, wherein the surface-wave sensor is connected with a membrane of an evacuated pressure capsule.

22. The arrangement of claim 13, wherein the surface-wave sensor is formed in one piece with a membrane.

23. The arrangement of claim 13, wherein the surface-wave sensor is formed in one piece with a tire, with the tire forming the carrier substrate and containing nanoscale carbon at least in an area of the surface-wave sensor.

24. The arrangement of claim 13, further comprising a flexible protective jacket for enveloping or covering at least one of the exciter electrode and the receiver electrode.

25. The arrangement of claim 13, further comprising measurement means for measuring the temperature.

26. The arrangement of claim 25, wherein the measurement means comprise at least one temperature-sensitive resistor.

27. The arrangement of claim 26, wherein the temperature-sensitive resistor is arranged in one piece in certain areas with at least one of the exciter electrode and the receiver electrode.

28. A tire intended for being filled with a gas, comprising at least one arrangement for measuring the pressure according to claim 13.

29. The tire of claim 28, wherein the at least one arrangement for measuring the pressure is placed at a location subjected to little thermal stress.

30. The tire of claim 28, wherein the at least one arrangement for measuring the pressure is arranged on an inside surface or an inside layer of the tire.

31. The tire of claim 28, wherein the at least one arrangement for measuring the pressure is integrated in an inner structure of the tire.

32. The tire of claim 31, wherein the structure is located in an area selected from the group consisting of layer of fabric, belt, and carcass.
